(19) United States
(12) Patent Application Publication
(10) Pub. No.: US 2015/0134892 A1
(43) Pub. Date: May 14, 2015

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Keigo Goda, Kawasaki-shi (JP)

(21) Appl. No.: 14/514,667

(22) Filed: Oct. 15, 2014

(30) Foreign Application Priority Data
Nov. 8, 2013 (JP) 2013-232580

(51) Int. Cl. G06F 3/06

(52) U.S. Cl. CPC G06F 3/0679; G06F 3/065; G06F 3/0619
USPC 711/103

(57) ABSTRACT

In an information processing apparatus and a method of controlling the information processing apparatus having a non-volatile main memory, allocates a memory area to be used for processing of an application in the non-volatile main memory, in a case where an instruction of processing by the application is received, and stores data in the allocated memory area. The apparatus and method clear data stored in the memory area and release the memory area, when processing for the data stored in the memory area by the application has completed.

### BACKGROUND OF THE INVENTION

1. Field of the Invention

The present invention relates to an information processing apparatus, a method of controlling the same, and a storage medium.

2. Description of the Related Art

Conventionally, in information processing apparatuses including an image forming apparatus, for reasons of cost and read/write speed, it is common to employ a volatile memory such as, for example, DRAM as a main memory that holds programs that a CPU executes or various data. Because for a non-volatile memory which is low-cost, such as a flash memory, a read/write speed is slow, such a memory is inappropriate for use as a main memory. However, in recent years, because non-volatile memories capable of high speed read/write, such as, for example, MRAM (Magnetoresistive Random Access Memory), have come be usable at low-cost, an electronic device that uses this kind of memory as a main memory has come to be realistic.

In an image forming apparatus that employs a non-volatile memory such as an MRAM as a main memory, unlike conventional apparatuses that use DRAM as a main memory, the contents of the main memory remain even if the power source of the image forming apparatus is turned off. With regards to security, because the contents stored in the main memory are left as is even if the power source of the apparatus is turned off in this way, there is a risk that information will leak.

In conventional apparatuses, there are many cases in which, after an application program is stored in an area of a main memory, a state, in which a program area of the main memory used by the application is occupied, remains even if the usage of the application completes. For example, when a destination address of a FAX is input by operating a console unit of an image forming apparatus, the destination address is held in an area of the main memory, and even if the information becomes unnecessary, the information continues to be held until it is overwritten by other data. This is because, in a conventional apparatus that uses DRAM as the main memory, the contents of the memory disappear due to the power source being turned off, and so it is not necessary to clear the contents of the main memory. However, with an image forming apparatus that uses a non-volatile memory for the main memory, there is the possibility that in a case in which the apparatus is stolen, for example, the contents stored in the main memory will be acquired by a third party, and important information will leak.

In order to prevent these kinds of situations, updating, so as to clear the contents of the main memory upon completion of an application program created with a volatile main memory in mind, can be considered, but there are large costs associated with this. For this reason, a technique that prevents leakage of information caused by a non-volatile main memory without modifying application programs that have existed conventionally is desirable. For example, in Japanese Patent Laid-Open No. 2006-48506, a technique is proposed in which, when an application program executed on an information processing apparatus completes, the application program clears the contents held in a memory area of the main memory that the application program was using.

In an embedded device such as a general image forming apparatus, executing application programs is not caused to terminate. For example, an image forming apparatus equipped with a FAX function comprises a FAX application, and the FAX application continuously awaits reception of image data through a telephone line and then prints received image data. Because it is not known when FAX data will be transmitted, the FAX application is executed continuously, and the application does not terminate. This is not limited to the FAX function, and is a configuration often seen in embedded devices other than image forming apparatuses. In this way, conventionally, the contents of the main memory are not cleared so long as the application program is not terminated, and so there is a possibility that the contents of the main memory will be held, as is, in an apparatus comprising a non-volatile main memory, and that important information will leak. Also, in a case where an image forming apparatus comprising a non-volatile main memory is stolen, there is the possibility that the contents of the main memory stored in a non-volatile manner will be read by a third party and that important information will leak.

### SUMMARY OF THE INVENTION

An aspect of the present invention is to eliminate the above-mentioned problems with conventional technology.

A feature of the present invention is to provide a technique in which, even in a case where an application program does not terminate, data is cleared from a non-volatile main memory, and information leakage is prevented.

The present invention in its first aspect provides an information processing apparatus having a non-volatile main memory, the information processing apparatus comprising: an allocation unit configured to allocate in the non-volatile main memory, in a case where an instruction of processing by an application is received, a memory area to be used for the processing of the application; a storage unit configured to store data in the allocated memory area; and a release unit configured to clear data stored in the memory area and to release the memory area, when processing for the data stored in the memory area by the application has completed.

The present invention in its second aspect provides a method of controlling an information processing apparatus having a non-volatile main memory, the method comprising: allocating in the non-volatile main memory, in a case where an instruction of processing by an application is received, a memory area to be used for the processing of the application; storing data in the allocated memory area; and clearing data stored in the memory area and releasing the memory area, when processing for the data stored in the memory area by the application has completed.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for showing a configuration of an image forming apparatus according to a first embodiment of the present invention.

FIG. 2 is a block diagram for explaining a configuration of a controller according to the first embodiment.

FIG. 3 depicts a view for explaining a memory map of an MRAM which is a main memory according to the first embodiment.

FIGS. 4A to 4C depict views for explaining states in which a heap area is used in the image forming apparatus according to the first embodiment.

FIG. 5 is a flowchart for describing an overview of a copy operation by the image forming apparatus according to the first embodiment.

FIG. 6 is a flowchart for describing processing for allocating a memory area that a CPU of the image forming apparatus according to the first embodiment executes.

FIG. 7 is a flowchart for describing processing for releasing a memory area that the CPU of the image forming apparatus according to the first embodiment executes.

FIG. 8 is a flowchart for describing processing for releasing a memory area that the CPU of the image forming apparatus according to a second embodiment executes.

### DESCRIPTION OF THE EMBODIMENTS

Embodiments of the present invention will now be described hereinafter in detail, with reference to the accompanying drawings. It is to be understood that the following embodiments is not intended to limit the claims of the present invention, and that not all of the combinations of the aspects that are described according to the following embodiments are necessarily required with respect to the means to solve the problems according to the present invention.

In this embodiment, an information processing apparatus according to the present invention is explained with the example of an image forming apparatus.

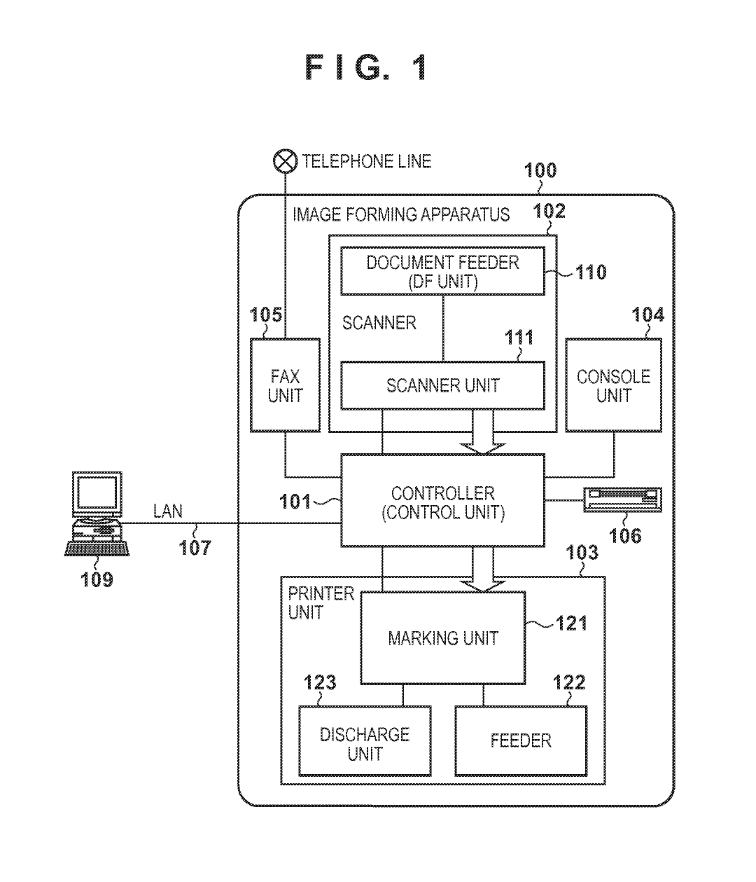

FIG. 1 is a block diagram for showing a configuration of an image forming apparatus 100 according to a first embodiment of the present invention.

A controller (control unit) 101 connects to a scanner 102, a printer unit 103, a console unit 104, a FAX unit 105, a storage unit (HDD) 106, and a LAN 107, and controls operation of these. The scanner 102 optically reads an image of an original, transforms the image into a digital image, and outputs the digital image. The printer unit 103, based upon image data, prints an image to a sheet (a recording medium) such as a paper sheet. The console unit 104 comprises a user interface, and a user makes an instruction for operation to the image forming apparatus 100 by operating the console unit 104. The storage unit 106 is a storage unit such as a hard disk drive (HDD), or the like, which stores digital images, control programs, or the like. The FAX unit 105 transmits a digital image such as a facsimile signal to a telephone line, or the like, and receives a facsimile signal via the telephone line, or the like. The image forming apparatus 100 is able to perform input and output of digital image data with a computer 109 via the LAN 107, and receive jobs, instructions, or the like.

The scanner 102 has a document feeder 110 for conveying, one sheet at a time, a batch of originals placed on the document feeder 110 to a scanner unit 111, and the scanner unit 111 for optically scanning an original and transforming the original into digital image data, and the transformed image data is transmitted from the scanner unit 111 to the controller 101. The printer unit 103 has a feeder 122 for feeding a bundle of papers one sheet at a time, a marking unit 121 for printing an image onto a fed sheet, and a discharge unit 123 for discharging a sheet after printing.

The console unit 104 is equipped with operation buttons and a liquid crystal display panel, or the like, (not shown) by which a user instructs the image forming apparatus 100 to perform an operation such as one for copying of an image, and for presenting to the user various information of the image forming apparatus 100. Note that the display panel may be a touch panel.

Next, explanation will be given briefly for functions that the image forming apparatus 100 has.

Copy Function

The scanner 102 saves image data, obtained by reading an original, to the HDD 106, and prints by outputting to the printer unit 103.

Sending Function

The scanner 102 transmits image data, obtained by reading an original, to the computer 109 via the LAN 107.

Box Function

The scanner 102 stores image data, obtained by reading an original, to the HDD 106, and performs transmission or printing as necessary.

Print Function

A print job in a page description language, for example, which is received from the computer 109 is analyzed, and printed by the printer unit 103.

Facsimile Transmission Function

Image data, obtained by the scanner 102 reading an original, is transmitted to the telephone line via the FAX unit 105.

Facsimile Reception Function

Image data, received via the FAX unit 105 from the telephone line, is printed by the printer unit 103.

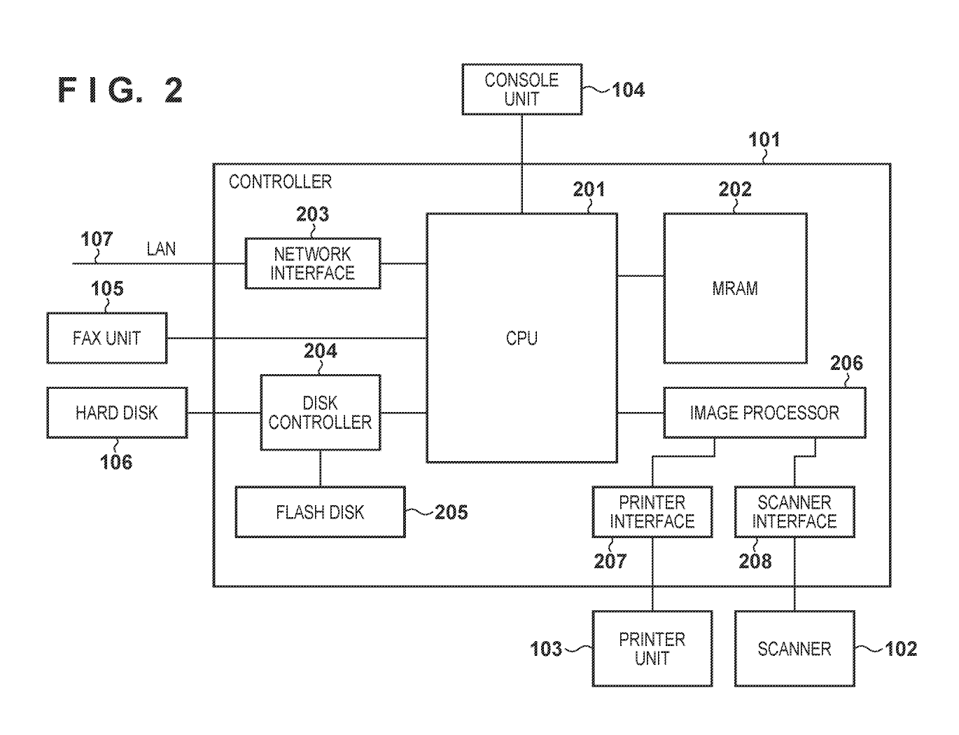

FIG. 2 is a block diagram for explaining a configuration of the controller 101 according to the first embodiment.

The controller 101 is a circuit including a so-called general-purpose CPU. A CPU 201 for overall control, and an MRAM 202 that the CPU 201 uses as a main memory are provided in the controller 101. The MRAM 202 is a non-volatile memory capable of high speed read/write. Also, a disk controller 204 for controlling a storage apparatus connects a flash disk (an SSD, or the like) 205, which is a comparatively low capacity storage apparatus configured on a semiconductor device, and the HDD 106, and controls reading/writing of these. The flash disk 205 stores programs such as an operating system (OS), an application program, or the like, that the CPU 201 executes. The controller 101 further has an image processor 206 for performing digital image processing in real-time. The printer unit 103 and the scanner 102 are connected to the image processor 206 through a printer interface 207 and a scanner interface 208 respectively. Also, externally the console unit 104 and the FAX unit 105 are connected to the controller 101. Also, the LAN 107 is connected via a network interface 203.

Note that FIG. 2 is a block diagram, and is simplified. For example, many CPU peripheral hardware devices such as a chip set, a bus bridge, a clock generator, or the like, are included in the CPU 201, and in the explanation of the present embodiment these are omitted because they are not required for the explanation of the present embodiment.

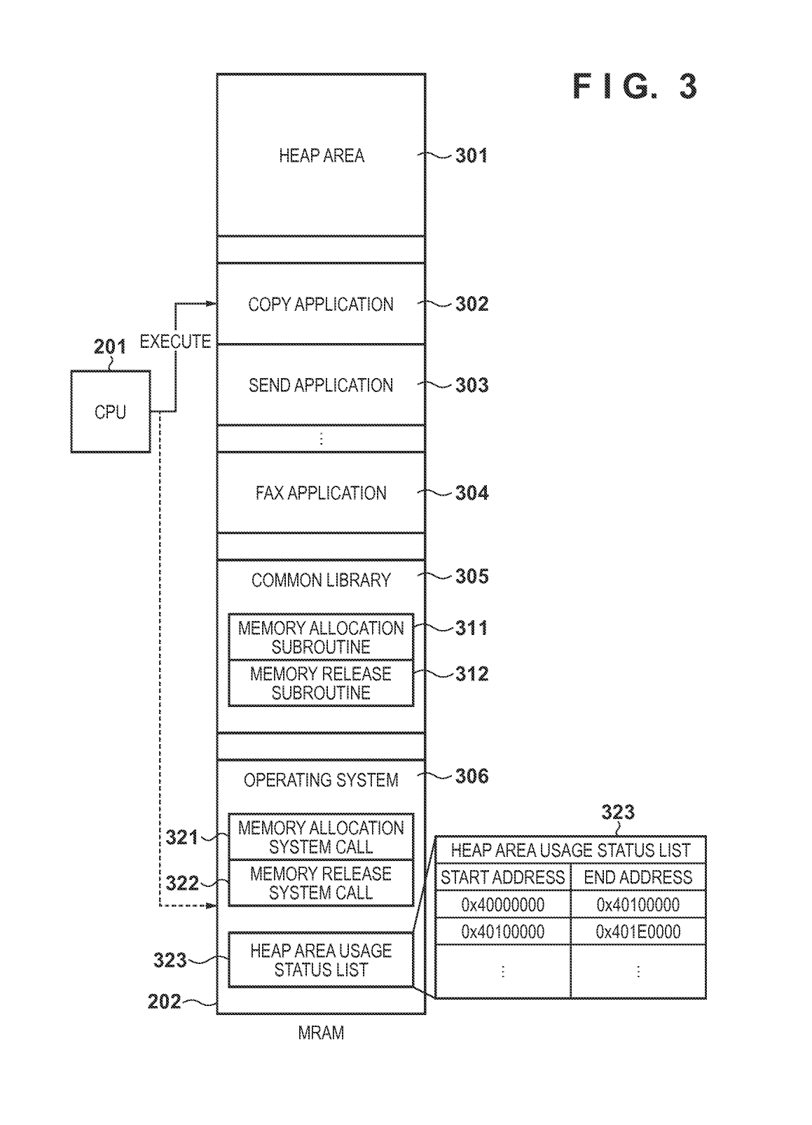

FIG. 3 depicts a view for explaining a memory map of the MRAM 202 which is a main memory according to the first embodiment.

If a power source of the image forming apparatus 100 is turned on, the CPU 201 loads the OS and the application programs from the flash disk 205 into the MRAM 202, and starts execution of these. FIG. 3 shows a view for illustrating a data configuration of the MRAM 202 after the execution of an application is started.

A heap area 301 is an area for use as a work memory when the image forming apparatus 100 executes various jobs. The heap area 301 is shared between a plurality of functions such as the copy function and the facsimile transmission function, and the functions allocate a memory area in the heap area 301 and use the memory area as necessary. This is because it is not necessarily the case that all of the functions of the image forming apparatus 100 are used simultaneously. For example, because both the copy function and the facsimile transmission function are functions that use the scanner 102, a user does not use these functions simultaneously.

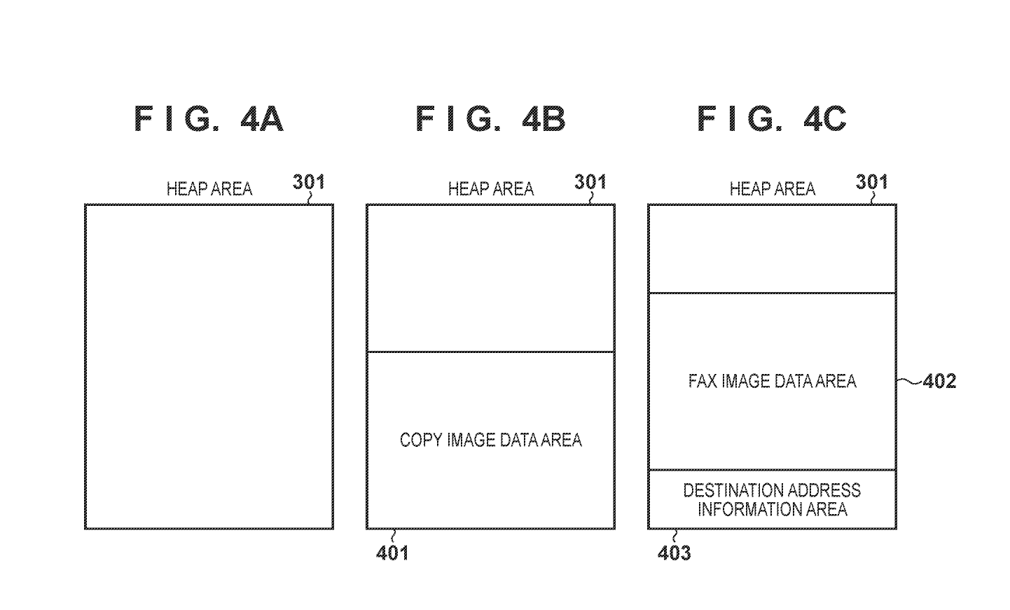

FIG. 4A through FIG. 4C depict views for explaining states in which the heap area 301 is used in the image forming apparatus 100 according to the first embodiment.

FIG. 4A illustrates the heap area 301 when in an idle state in which programs are not being executed. In this idle state, no special memory area is allocated in the heap area 301. FIG. 4B illustrates the heap area 301 when the copy function is used, and a portion of the heap area 301 is allocated to an image data area 401 for copying at this time. FIG. 4C illustrates a state in which the FAX function is used, and portions of heap area 301 are allocated to a FAX image data area 402 to store image data for a facsimile transmission and a destination address information area 403 to store destination address information of the facsimile respectively. In this way, by providing the heap area 301 shared by a plurality of functions, it is not necessary to prepare an individual memory area for each function, and the MRAM 202, which is a limited resource, can be used effectively.

Once again returning to FIG. 3, a copy application 302, a send application 303, and a FAX application 304 are application programs executed by the CPU 201 in order to realize functions of the image forming apparatus 100. These application programs are continuously in progress when a power source of the image forming apparatus 100 is ON, and the execution of the applications is not terminated. Of course this configuration is only one example, and configuration may be taken in which a number of application programs are further comprised.

A common library 305 is a program area from which processing executed commonly during execution of the plurality of application programs described above is extracted as subroutines which can be called by the application programs. In general, a plurality of subroutines are stored in the common library. The common library 305 according to the first embodiment is something from which processing, for application programs to use functions that the OS has, is extracted as subroutines. Extracting this kind of processing in order to use functions that the OS has as a common library is a common configuration for a computer system comprising the OS.

A memory allocation subroutine 311 and a memory release subroutine 312 are comprised in the common library 305. The memory allocation subroutine 311 is a program for performing processing which calls a function of the OS, and allocates in the heap area 301 a memory area required for an operation of an application program. The memory release subroutine 312 is a program which calls a function of the OS, and notifies the OS of a usage completion of the memory area of the heap area 301 allocated by the memory allocation subroutine 311. All of the above-mentioned application programs are configured so as to call the memory allocation subroutine 311 and the memory release subroutine 312 when the operation using the heap area 301 is executed.

An operating system (OS) 306 is a memory area into which the OS for controlling the controller 101 is loaded. The OS provides a function of resource management of the image forming apparatus 100, which comprises the MRAM 202, and a memory allocation system call 321, a memory release system call 322, and a heap area usage status list 323 are comprised in the OS 306. The memory allocation system call 321 is a program for realizing processing, which is for one of the functions of the OS, for allocating a memory area in the heap area 301. A portion of the memory area in the heap area 301, which is not being used by the application program currently, is allocated to an application program that requested the allocation. The memory release system call 322 is a program, which is one of the functions of the OS, for cancelling and allocation of a memory area in the heap area 301. An allocation of a memory area in the heap area 301, which is allocated to an application program, is canceled with the memory release system call 322.

The heap area usage status list 323 is used for management of the heap area 301. The memory allocation system call 321 is executed, and a range of addresses of memory areas allocated in the heap area 301 is registered in the heap area usage status list 323. By referencing this list 323, it is possible to distinguish where a memory area not yet allocated to an application program is in the heap area 301 during execution of the memory allocation system call 321. If the memory release system call 322 is executed, the address information indicating memory areas recorded in the heap area usage status list 323 is cleared.

In general, a modern CPU is provided with a function for protecting so that application programs cannot access a memory area on the main memory in which the OS exists. This is in order to prevent a function of the OS from being impaired due to a problem or a malfunction of the application programs. In such CPUs, an execution mode commonly referred to as a supervisor mode is provided, and by switching into this execution mode, the CPU becomes capable of accessing protected memory areas. The CPU 201 executes a program of an OS in the supervisor mode. The memory areas of the operating system 306 are protected, and the heap area usage status list 323 is within the protected memory areas. Of course, the configuration of the MRAM 202 as described above is only one example, and the present invention is not limited to this.

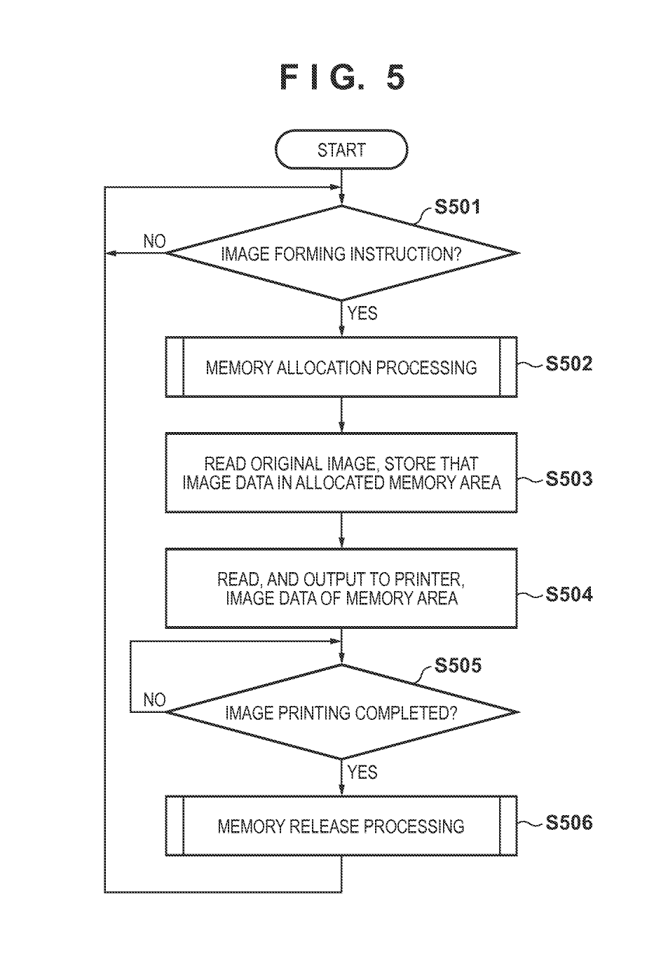

Next, an example of copy processing of an image forming operation that the controller 101 according to the first embodiment executes is explained with reference to FIG. 5.

FIG. 5 is a flowchart for describing an overview of a copy operation by the image forming apparatus 100 according to the first embodiment. This processing is executed by a user making an instruction for an image copy from the console unit 104, and the CPU 201 executing the copy application 302. Note that a program for executing this processing is installed in the HDD 106 or the flash disk 205, loaded into the MRAM 202 upon execution, and executed under the control of the CPU 201.

Firstly, the CPU 201, in step S501, awaits an image forming instruction from the user. Here, if a start instruction for a copy operation and necessary parameter input such as the number of sheets for copying are received from a user via the console unit 104, the processing is advanced to step S502. When that is not the case, continuing on, an instruction from a user is awaited in step S501. The CPU 201, in step S502, because a memory area for storing data necessary for a copy operation for copying image data, or the like, is necessary, by calling a function of the OS, allocates a memory area in the heap area 301. Detailed explanation will be given later for memory area allocation processing.

FIG. 4B illustrates a state of the heap area 301 after the memory area for storing the image data for the copying is allocated, and the copy image data area 401 is allocated for the heap area 301.

Next, the processing proceeds to step S503, the CPU 201 sets the copy image data area 401 as the storage destination for the image data for the image processor 206, and read instruction for reading an original is sent to the scanner 102 via the scanner interface 208. With this, the scanner 102 optically scans an original, transforms an image of the original into digital image data, and inputs the digital image data into the image processor 206. The image processor 206 applies image processing to the image data, and stores the result in the copy image data area 401.

Next, the processing proceeds to step S504, and the CPU 201, when the CPU 201 confirms that a fixed amount, or all, of the digital image data is entered into the copy image data area 401 in step S503, outputs the print instruction to the printer unit 103 via the printer interface 207. Here, the CPU 201 sets the copy image data area 401 to be an input source of image data for the image processor 206. With this, the image processor 206 reads out the image data from the copy image data area 401, and transmits the image data to the printer unit 103. With this, the image is printed onto a sheet by the printer unit 103.

Next, the processing proceeds to step S505, and the CPU 201 awaits a completion of the print processing of the image by the printer unit 103. Upon detection of print completion, the processing proceeds to step S506, and when that is not the case, continuing on, completion is awaited in step S505. The CPU 201, in step S506, because usage of the memory area for storing the image data ends, executes memory release processing for releasing the memory area allocated in the heap area 301 by calling a function of the OS. Details of the memory release processing will be explained later. After executing the memory release processing in this way, the inside of the heap area 301 is as in FIG. 4A. After this, once again the CPU 201 returns the processing to step S501, and the CPU 201 awaits an instruction of the user.

Note that in the copy application 302 according to the first embodiment, when the memory area is released by calling the function of the OS, processing for clearing the content of the memory area is not performed. In other words, the copy image data area 401, in the state in which the image data is stored by executing the processing up until step S503, is released by calling the function of the OS in step S506 in that state as is. This is general operation of conventional application programs created with the usage of a volatile memory such as a DRAM as a main memory in mind.

Here, the copy function, out of the plurality of functions of the image forming apparatus 100, is explained, but the basic flow of processing such as performing the image forming operation by allocating memory areas as necessary in the heap area 301, as described above, is common to other functions as well. Thus, explanation is only given for the operation of the copy application 302, and explanation of the operation of the send application 303 and the FAX application 304 is omitted.

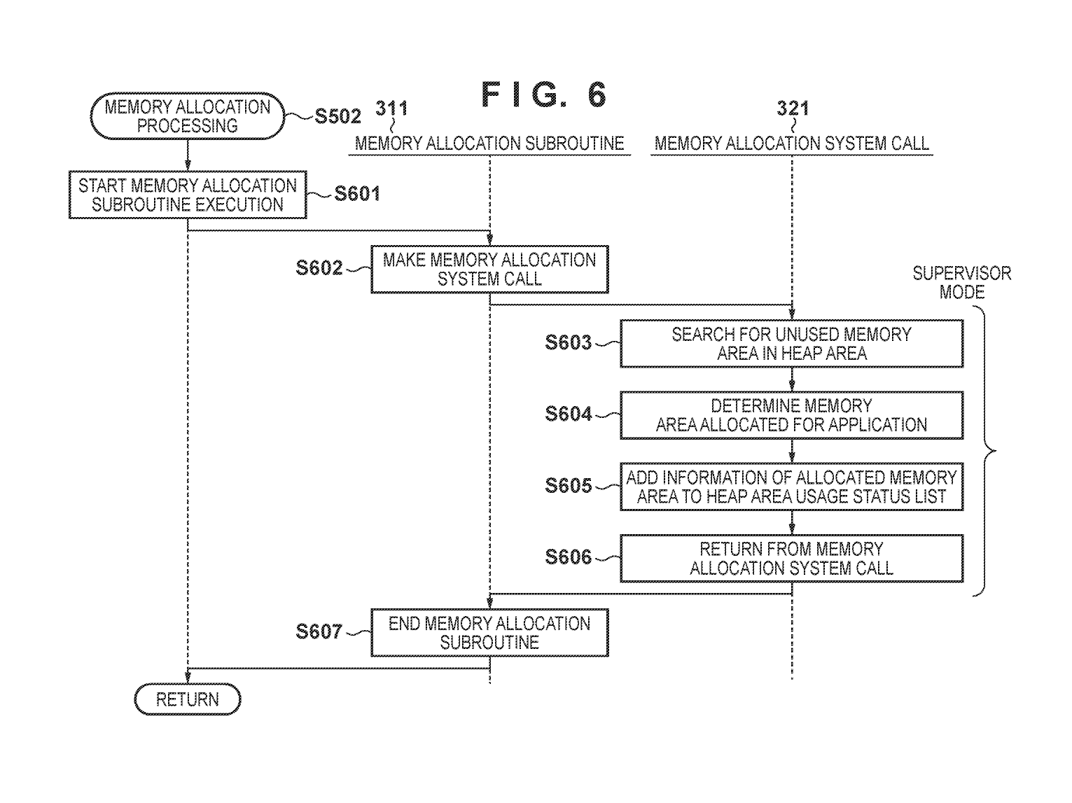

Next, the operation for allocating a memory area in the image forming apparatus 100 according to the first embodiment is explained with reference to the flowchart of FIG. 6. Because when the processing of the previously described FIG. 5 is executed, the CPU 201 executes memory allocation in the heap area 301 by calling the function of the OS, explanation will be given more clearly with reference to FIG. 6.

FIG. 6 is a flowchart for describing processing (step S502) for allocating the memory area, which the CPU 201 of the image forming apparatus 100 according to the first embodiment executes. Note that a program for executing this processing is installed in the HDD 106, loaded into the MRAM 202 upon execution, and executed under the control of the CPU 201.

The CPU 201, in step S601, starts the execution of the memory allocation subroutine 311 in the common library 305. It is common for a size of the memory area, for which allocation is requested upon the call of the subroutine, to be given as a parameter for the application program. Note that, as explained previously, the common library 305 extracts the processing, which is commonly executed by a plurality of application programs, as a subroutine. Therefore, there is no limitation to a case in which the CPU 201 executes the copy application 302, and even in a case where the send application 303 or the FAX application 304 is executed, the same memory allocation subroutine 311 is called.

Next, the processing proceeds to step S602, and the CPU 201 calls the memory allocation system call 321 in order to execute the allocation of the memory area, which is a function of the OS. For the memory allocation system call 321, which is an executable program, the CPU 201 must switch the operation mode to the supervisor mode in order to perform the execution because the memory allocation system call 321 is in the memory area, which is protected. The approach to the switching to the supervisor mode differs depending on the CPU, but it is common to use a special executable program instruction by the CPU 201, called a system call instruction. The memory allocation subroutine 311, which is an executable program, is such a system call instruction.

The CPU 201, in step S602, stores a predetermined identification number that indicates the memory allocation system call 321, and the size of the memory area for which the allocation is requested in a predetermined register of the CPU 201, and executes the system call instruction. With this, the CPU 201 interrupts the execution of the memory allocation subroutine 311, and switches to the supervisor mode. The CPU 201, in the supervisor mode, starts the execution of the memory allocation system call 321, and the processing proceeds to step S603. The processing thereafter is executed in the supervisor mode.

The CPU 201, in step S603, searches for an unused memory area of the heap area 301 which is not allocated for an application program. This can be performed by referencing the heap area usage status list 323. Next, the processing proceeds to step S604, and the CPU 201, from the unused areas found in step S603, selects an area of the size for which the application program requested the allocation, and determines the selected area to be the memory area to be allocated for the application program. Then, the processing proceeds to step S605, and the CPU 201 adds information of an address of the memory area determined to the memory area to be allocated in step S604 to the heap area usage status list 323. Then, the processing proceeds to step S606, and the CPU 201, because the operation of the memory allocation function of the OS has completed, terminates the execution of the memory allocation system call 321. Here, operation of the CPU 201 in the supervisor mode is ended by using a special executable program instruction by the CPU 201, called a system call completion instruction. Note that the memory allocation system call 321 is an example of the system call completion instruction. In this way, the CPU 201, in step S606, stores the address information of the allocated memory area to a predetermined register, and executes the system call completion instruction. With this, the CPU 201 ends the supervisor mode, and resumes execution of the interrupted memory allocation subroutine 311.

In this way, the processing proceeds to step S607, and the CPU 201 ends the execution of the memory allocation subroutine 311, and resumes the execution of the application program that called the subroutine.

In this way, in the image forming apparatus 100 according to the first embodiment, the operation for allocating the memory area is executed.

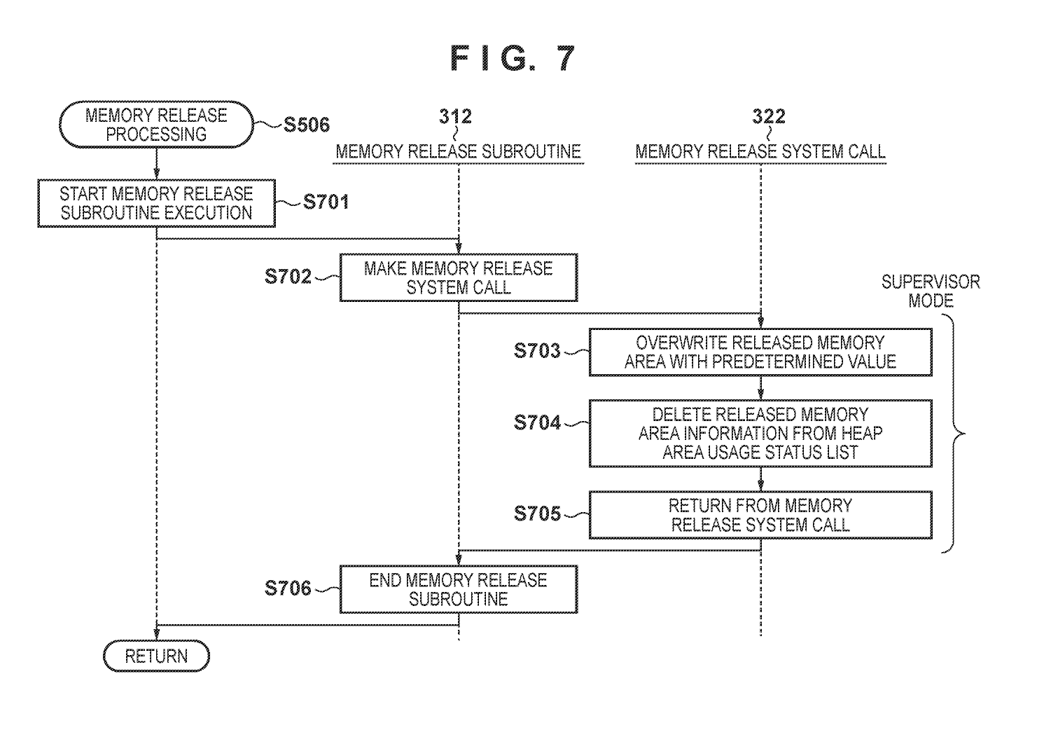

Next, explanation will be given for a memory area release operation, which is a characteristic operation of the image forming apparatus 100 according to the first embodiment, with reference to the flowchart of FIG. 7. Because this is for the CPU 201 to release, by calling the function of the OS, the memory area allocated in the heap area 301 by the previously described memory area release processing upon the processing shown in the previously described FIG. 5 being executed, explanation will be given more simply with reference to FIG. 7.

FIG. 7 is a flowchart for describing processing (step S506) for releasing the memory area, which the CPU 201 of the image forming apparatus 100 according to the first embodiment executes. Note that a program for executing this processing is installed in the HDD 106 or the flash disk 205, loaded into the MRAM 202 upon execution, and executed under the control of the CPU 201.

Firstly, in step S701, execution of the memory release subroutine 312 of the common library 305 is started. It is common for an address of the memory area to be released upon the call of the subroutine to be given as a parameter for the application program. Similarly to the previously described memory area allocation operation, the CPU 201 executes the same memory release subroutine 312 in the cases in which the CPU 201 was executing the copy application 302 or the FAX application 304.

Next, the processing proceeds to step S702, and the CPU 201 calls the memory release system call 322 in order to execute the memory release, which is a function of the OS. In step S702, the CPU 201 stores a predetermined identification number indicating the memory release system call 322 and an address of the memory area for which the release is requested in a predetermined register of the CPU 201, and executes the system call instruction. With this, the CPU 201 interrupts the execution of the memory release subroutine 312, and switches to the supervisor mode. The CPU 201 in the supervisor mode starts the execution of the memory release system call 322, and the processing proceeds to step S703. The processing thereafter is executed in the supervisor mode.

In step S703, the CPU 201 clears the contents stored in the memory area at the point in time when the application program releases the memory area. More specifically, the CPU 201 overwrites all of the contents of the memory area with a predetermined value determined in advance. For example, all bits in the memory area are cleared by setting them to zero. By this operation, it becomes impossible to read out from the MRAM 202 the contents stored in the memory area up until that point. This is a characteristic operation of the first embodiment which is not present in conventional techniques.

Next, the processing proceeds to step S704, and the CPU 201 deletes from the heap area usage status list 323 the information of the address of the released memory area. With this, thereafter, the memory area may become the target of an allocation in a case where a memory area allocation is requested by another application program. Next, the processing proceeds to step S705, and the CPU 201 executes the system call completion instruction in order to complete the execution of the memory release system call 322 because the operation of the memory area release function of the OS has completed. With this, the CPU 201 ends the supervisor mode, and resumes execution of the interrupted the memory release subroutine 312.

In this way, the processing proceeds to step S706, and the CPU 201 ends the execution of the memory release subroutine 312, and resumes the execution of the application program that called the subroutine.

In this way, in the image forming apparatus 100 according to the first embodiment, the memory area release operation is performed.

As explained above, by virtue of the image forming apparatus according to the first embodiment, even in a device in which application programs are not terminated, it is possible to clear from the main memory data and destination address information for which there is the necessity to maintain confidentiality. With this, even in a case where a non-volatile memory such as an MRAM is employed as a main memory, it is possible to avoid important information leaking.

Note that because the memory clear operation is executed immediately at the point in time when usage of the memory area of the main memory ends, data for which there is the necessity of preventing leakage of information never exists in the main memory for long. Because of this, even in a case where the power source of the device is pulled out from the outlet and there is a theft of the device, the possibility that such information will leak can be eliminated.

Also, because the contents of the memory are cleared by the function of the OS, it is not necessary for application programs to be provided with a function for clearing the contents of the main memory. Because of this, it is possible to install unchanged application programs for conventional devices that use a volatile memory such as a DRAM as the main memory onto the image forming apparatus according to the first embodiment without changing the application programs. In other words, it is possible to reduce the costs of newly modifying application programs for the apparatus which uses the non-volatile memory.

Note that in the first embodiment, in order to clear the contents of the memory area, the memory is overwritten by a predetermined value, but this configuration is only one example. A configuration in which the memory is overwritten by random values upon execution of the clear processing may also be taken, and the present invention is not limited to this configuration.

### Second Embodiment

In the first embodiment described above, the contents of the MRAM 202 are cleared in a state in which the CPU 201 is in the supervisor mode upon release of the memory area, but configuration may also be taken such that the contents are cleared in a state other than the supervisor mode.

In the second embodiment, explanation will be given for a case in which the contents of the allocated memory area are cleared by executing the memory release subroutine 312 rather than the memory release system call 322 executed by the CPU 201 in the supervisor mode.

Note that the second embodiment is equivalent to the previously described first embodiment except for the flow that the CPU 201 executes upon the release of the memory area. In the explanation below, explanation will only be given for points that differ from the first embodiment, and explanation will be omitted for points that are the same.

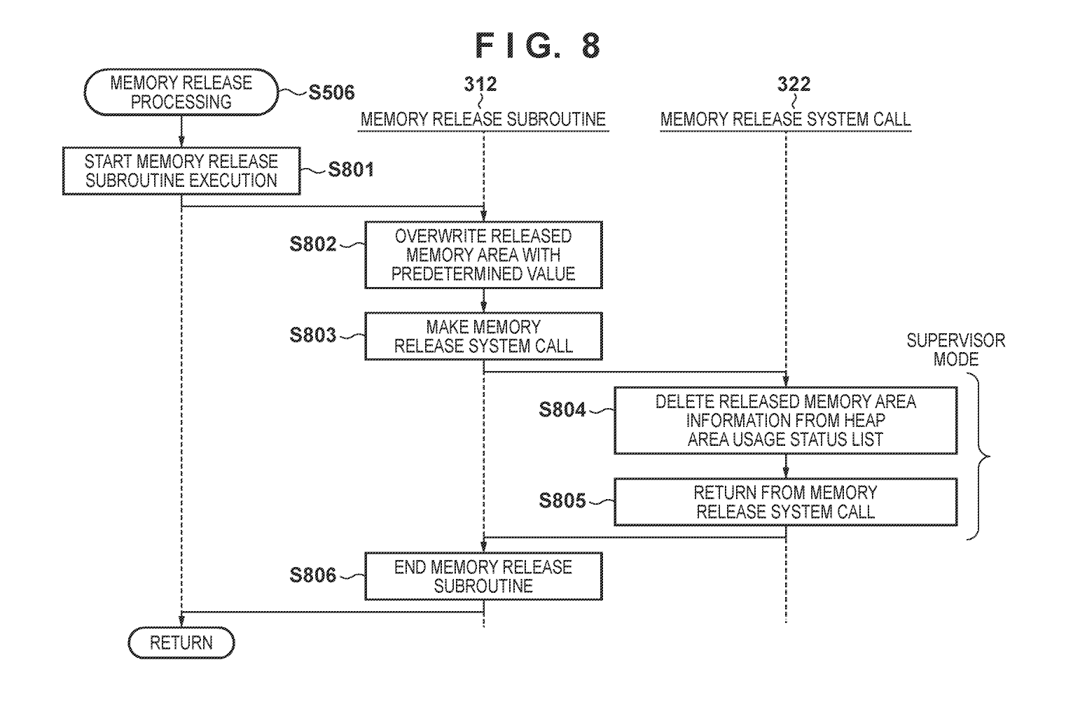

FIG. 8 is a flowchart for describing processing for releasing a memory area that the CPU 201 of the image forming apparatus 100 according to a second embodiment executes. The second embodiment is the same as the first embodiment except for the point that the CPU 201, in place of the flow of FIG. 7, executes the flow of FIG. 8. Note that a program for executing this processing is installed in the HDD 106 or the flash disk 205, loaded into the MRAM 202 upon execution, and executed under the control of the CPU 201.

In step S801, execution of the memory release subroutine 312 of the common library 305 is started. It is common for an address of the memory area to be released upon the call of the subroutine to be given as a parameter for the application program. The CPU 201 executes the same the memory release subroutine 312 when the copy application 302 or the FAX application 304 is executed.

Next, in step S802, the CPU 201 clears the contents stored in the memory area at the point in time when the application program releases the memory area. More specifically, the CPU 201 overwrites all of the contents of the memory area with a predetermined value which is determined in advance. For example, all bits in the memory area are cleared by setting them to zero.

Next, in step S803, and the CPU 201 calls the memory release system call 322 in order to execute the memory area release, which is a function of the OS. The CPU 201 stores a predetermined identification number indicating the memory release system call 322 and an address of the memory area for which the release is requested in a predetermined register of the CPU 201, and executes the system call instruction. With this, the CPU 201 interrupts the execution of the memory release subroutine 312, and switches to the supervisor mode. The CPU 201 in the supervisor mode starts the execution of the memory release system call 322, and the processing proceeds to step S804. The processing thereafter is executed in the supervisor mode.

Next, in step S804, and the CPU 201 deletes from the heap area usage status list 323 the address information of the memory area. With this, thereafter, the memory area may become the target of an allocation in a case where a memory area allocation is requested from another application program. Next, the processing proceeds to step S805, and the CPU 201 executes the system call completion instruction in order to complete the execution of the memory release system call 322 because the operation of the memory area release function of the OS has completed. With this, the CPU 201 ends the supervisor mode, and resumes execution of the interrupted the memory release subroutine 312.

Then, in step S806, and the CPU 201 ends the execution of the memory release subroutine 312, and resumes the execution of the application program that called the subroutine.

In this way, in the image forming apparatus 100 according to the second embodiment, the memory area release operation is performed.

By the second embodiment, as explained above, the CPU 201 is capable of clearing the contents of the allocated memory area even if the CPU 201 is not in the supervisor mode. Similarly to the first embodiment, information leakage can be prevented even on a device that does not terminate application programs because the contents of the non-volatile main memory can be cleared.

Also, by the above described configuration, configuration is taken such that all of the application programs call the memory release subroutine 312 after using the heap area 301, it is not necessary to provide individual application programs with a function for executing a memory clear. In other words, according to the second embodiment, the cost of newly creating application programs for the apparatus that uses the non-volatile memory for the main memory can be reduced.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-232580, filed Nov. 8, 2013, which is hereby incorporated by reference herein in its entirety.

What is claimed is:

1. An information processing apparatus having a non-volatile main memory, the information processing apparatus comprising:
an allocation unit configured to allocate in the non-volatile main memory, in a case where an instruction of processing by an application is received, a memory area to be used for the processing of the application;
a storage unit configured to store data in the allocated memory area; and
a release unit configured to clear data stored in the memory area and to release the memory area, when processing for the data stored in the memory area by the application has completed.

2. The information processing apparatus according to claim 1, wherein the allocation unit is executed by that the application calls a subroutine for allocating the memory area and the subroutine calls a subroutine, for allocating the memory area, of an operating system by a system call instruction.

3. The information processing apparatus according to claim 1, wherein the release unit is executed by that the application calls a subroutine for releasing the memory area and the subroutine calls a subroutine, for releasing the memory area, of an operating system by a system call instruction.

4. The information processing apparatus according to claim 2, wherein the subroutine, for allocating the memory area, of the operating system is executed in a supervisor mode.

5. The information processing apparatus according to claim 1, wherein the processing for the data stored in the memory area is print processing.

6. The information processing apparatus according to claim 1, wherein the memory area is allocated in a heap area of the non-volatile main memory.

7. The information processing apparatus according to claim 6, further comprising a memory unit configured to store information indicating a usage status of the heap area,
wherein upon execution of the subroutine for allocating the memory area, the information stored in the memory unit is referenced, and the memory area is allocated in an unused area of the heap area.

8. The information processing apparatus according to claim 1, wherein the release unit clears the data stored in the memory area by writing a predetermined value into the memory area.

9. The information processing apparatus according to claim 1, wherein the application is an application used for a copy function.

10. A method of controlling an information processing apparatus having a non-volatile main memory, the method comprising:
allocating in the non-volatile main memory, in a case where an instruction of processing by an application is received, a memory area to be used for the processing of the application;
storing data in the allocated memory area; and
clearing data stored in the memory area and releasing the memory area, when processing for the data stored in the memory area by the application has completed.

11. A non-transitory computer-readable storage medium storing a program for causing a computer to function as an information processing apparatus, having a non-volatile main memory, the information processing apparatus comprising:
an allocation unit configured to allocate in the non-volatile main memory, in a case where an instruction of processing by an application is received, a memory area to be used for the processing of the application;
a storage unit configured to store data in the allocated memory area; and
a release unit configured to clear data stored in the memory area and to release the memory area, when processing for the data stored in the memory area by the application has completed.
